(19) United States
(12) Patent Application Publication
(10) Pub. No.: US 2008/0190531 A1
(43) Pub. Date: Aug. 14, 2008

(54) Snow and Ice Patch For Tires

(76) Inventor: Mabra Holeyfield, Memphis, TN (US)

Correspondence Address: Kimberly Flynn, 4075 Chatham Drive, King George, VA, 22485, US

(21) Appl. No.: 11/673,146

(22) Filed: Feb. 9, 2007

(51) Int. Cl. B60C 27/06

(52) U.S. Cl. 152/208

(57) ABSTRACT

A snow and ice patch for tires that can be temporarily affixed to a vehicle tire by means of an adhesive. The patch includes flat and rectangular panel with a plurality of opposite surface layers disposed thereon. The first of the plurality of surface layers includes an adhesive that is protected by a removable thin plastic film and allows the patch to be instantly affixed to the surface of the tire. The second of the plurality of surface layers includes an abrasive gripping surface that provides extra traction in slippery conditions such as ice or snow.

### BACKGROUND OF INVENTION

1. Field of Invention

The present invention related to a snow and ice patch for tires that can be temporarily affixed to a vehicle tire to provide extra traction in slippery conditions such as snow or ice.

2. Description of the Prior Art

A tire having a normal tread usually provides adequate traction in favorable weather conditions, however; in slippery weather conditions such as snow or ice the tire tread alone may not be sufficient. There is an ongoing need to improve traction on tires and have been numerous techniques and the snow and ice patch is employed in an attempt to meet such a need Many of the other traction enhancing devices on the market involve utilizing chains, metal brackets, cables, and plates that are not easy to install or remove. In many cases they may requires one or more tools and the use of considerable force.

Over the years, a number of inventions have been developed relating to improving the traction of tires. The following U.S. patents are representative of some of those inventions.

U.S. Pat. No. 6,581,661 to Morrison discloses a patch that is used to increase traction between the tires of a vehicle and a slippery surface that is fitted across the tire tread and tightened about the tire and tire rim with the use of a ratchet.

U.S. Pat. No. 5,645,659 to Ivan discloses a tire add-on traction patch that includes a ring shaped base wall which has a circular inner edge portion and a circular outer edge portion U.S. Pat. No. 5,123,469 to Miller discloses a tire traction chain having a tread or contact section with spikes and two side sections that are linked with one another.

U.S. Pat. No. 5,779,827 to Olexson discloses a tire traction improvement patch for installation on a wheel mounted vehicle tire that includes a base assembly and a base plate.

The above cited patents, although varying in structure; all have a complex installation process that requires tools and a multiple steps.

In most places a traction enhancing patch will not be needed except in the winter months and on certain days when the road conditions are slippery from ice or snow. Therefore, it would be desirable to have a patch that can be easily and conveniently installed, removed, or replaced.

A need exists for a self-adhesive traction patch that can be temporarily affixed to the surface of a tire without the need for special tools and a time consuming installation. A further need exist for such a patch that can be attached instantly when slippery conditions such as snow and ice are periodically encountered and easily removed when not needed.

### SUMMARY OF INVENTION

The present invention meets the needs identified above by providing a snow and ice patch for improving the traction of vehicle tires, the patch comprising a flat and rectangular panel comprising a plurality of opposite surface layers disposed thereon. The first of the plurality of surface layers include an adhesive that allows the patch to be temporarily affixed to the surface of a tire. This adhesive is protected by a thin plastic film. The second of the plurality of surface layers includes an abrasive gripping surface that provides extra traction in slippery conditions such as ice or snow.

The patch is attached to the tire by peeling away the thin plastic film to expose the adhesive surface and placing the adhesive surface securely against the outer tread wall of the tire. In the preferred embodiment, an addition patch may be affixed to the opposite side of the tire to promote additional traction. In yet another embodiment, the patch may be decreased or increased in sized to accommodate other types of tires.

The above brief description set forth rather broadly the more important features of the present invention in order that the detailed description that follows may be better understood. It is understood that the invention is not limited in its application to the details of the construction and to the arrangements of the components set forth in the following description or illustrated in the drawings. The invention is capable of other embodiments and of being carried out in various ways.

The primary object of the present invention is to provide a new and improved tire traction enhancing patch which has all of the advantages of the prior art and none of the disadvantages.

A primary advantage of the present invention is that it is easily and quickly installed and removed from a tire.

It is another object of the present invention to provide a snow and ice patch that can be easily and efficiently manufactured and marketed

Another advantage of the present invention is that the vehicle does not have to be moved to place the patch on the tire.

It is a further object of the present invention to provide a new and improved tire traction enhancing patch that is low in cost to manufacture and resale.

A further advantage of the present invention is that the snow and ice patch can be easily and conveniently stored. The foregoing features and advantages of the present invention will be described in detail subsequently and illustrated in the accompanying drawings.

### BRIEF DESCRIPTION OF THE DRAWINGS

The invention will be better understood and objects other than those set forth above will become apparent when consideration is given to the following detailed description thereof. Such description makes reference to the annexed drawing wherein:

FIG. 1 is a view of the snow and ice patch affixed to the surface of a vehicle tire.

FIG. 2 is a bottom view of the snow and ice patch which is the abrasive surface.

FIG. 3 is a top view of the snow and ice patch which is the adhesive surface.

FIG. 4 is a perspective view of the patch showing the different layers and surfaces.

FIG. 5 is a front view of the snow and ice patch.

FIG. 6 is a side view of the snow and ice patch.

### DESCRIPTION OF THE PREFERRED EMBODIMENTS

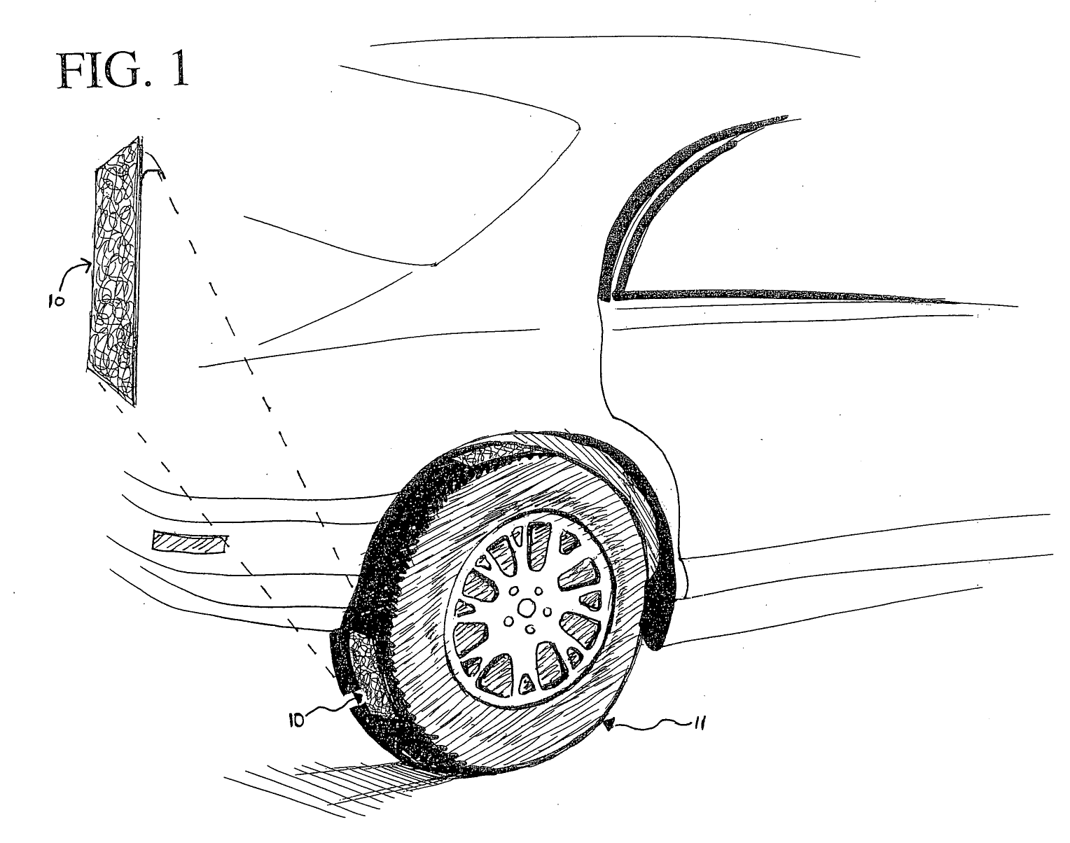

In the following descriptions certain specific details are set forth to provide a thorough understanding of various embodiments of the invention. With reference now to the drawings, and in particular to FIGS. 1 through 6 thereof, a new snow and ice patch for tires embodying the principles and concepts of the present invention will be described.

As best illustrated in FIGS. 1 though 6, the snow and ice patch for tires comprises a flat and rectangular panel comprising a plurality of opposite surface layers disposed thereon. The first of the plurality of surface layers include an adhesive that allows the patch to be temporarily affixed to the surface of a tire. This adhesive is protected by a thin plastic film. The second of the plurality of surface layers includes an abrasive gripping surface that provides extra traction in slippery conditions such as ice or snow.

In closer detail of FIG. 1, the traction enhancing patch 10 is provided for attachment on a wheel-mounted vehicle tire 11. The patch in its simplest form may be added to the outer perimeter of a vehicle tire without the need to move the tire or the vehicle. When a vehicle suddenly loses traction at a stop light or sign or in a parking lot or driveway, the driver will now have an easy, affordable, and convenient way to rectify the problem on the spot. With the ease of installation, that does not require movement of the vehicle to attach the patch; road closures due to stalled vehicles will be greatly reduced. This will therefore increase driving safety. Few people will hesitate to install this traction enhancing device because its easy installation does not require one to get dirty or wet.

The traction enhancing patch differs greatly from the conventional tire chains that require a vehicle to be moved in order to place the chains all the way around the circumference of the tire. This inventive patch is attachable anywhere on the outer perimeter of the tire tread that is not in contact with the ground, as seen in FIG. 1. Thus, the present invention can be installed without requiring movement of the vehicle. It should be understood by those having ordinary skill in the art, that more than one patch may be attached to each tire depending on the weather conditions that will directly affect the need.

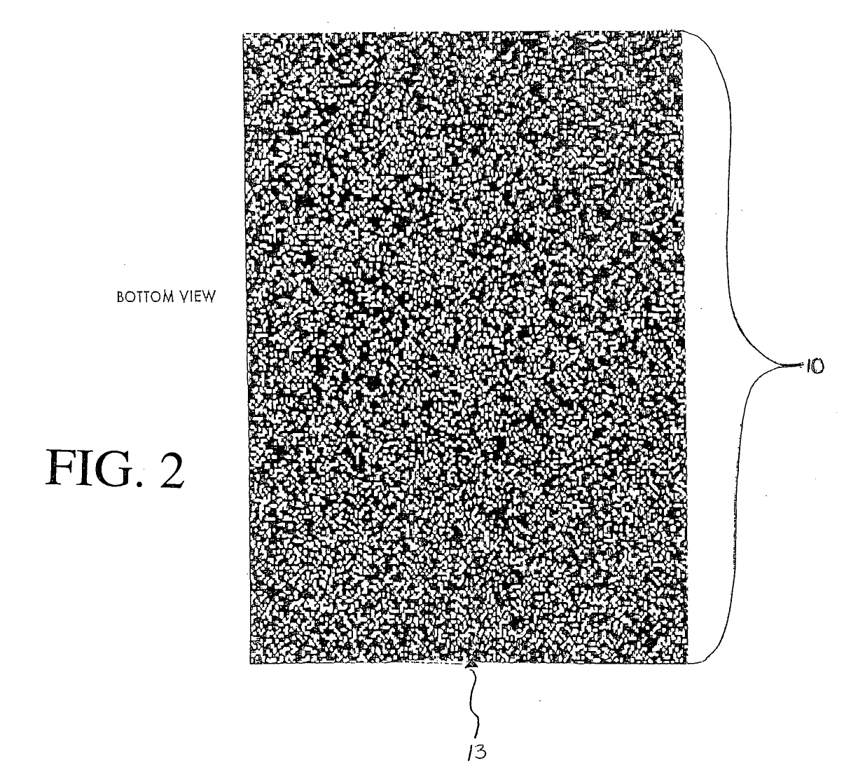

The invention is a traction enhancing patch preferably comprising a plurality of surface layers for attachment to a vehicle tire and for contact with the ground. As shown in FIGS. 2, 3, and 4, the patch 10 comprises a plurality of opposite surface layers 13 and 14 and a thin plastic film 15.

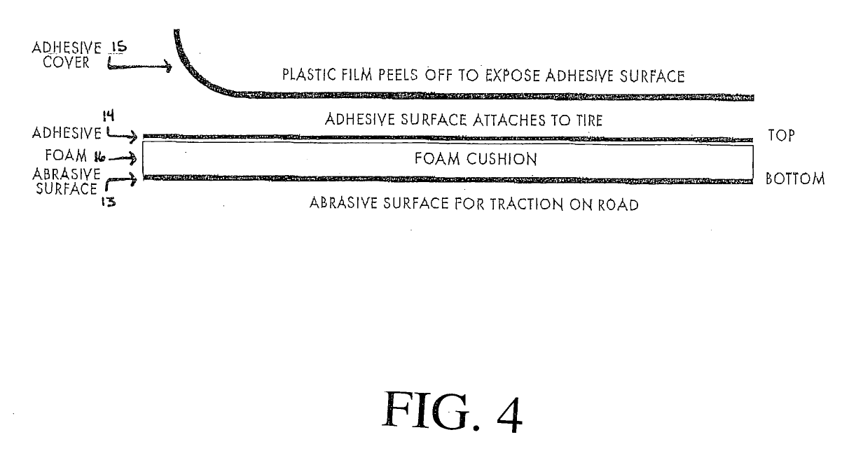

With reference to FIGS. 2 and 4, the bottom view of the patch is the second of the plurality of surface layers that is adhesively coupled to the foam cushion mid panel 16 and has an abrasive gripping surface 13. This surface is preferably a roughed surface that provides traction.

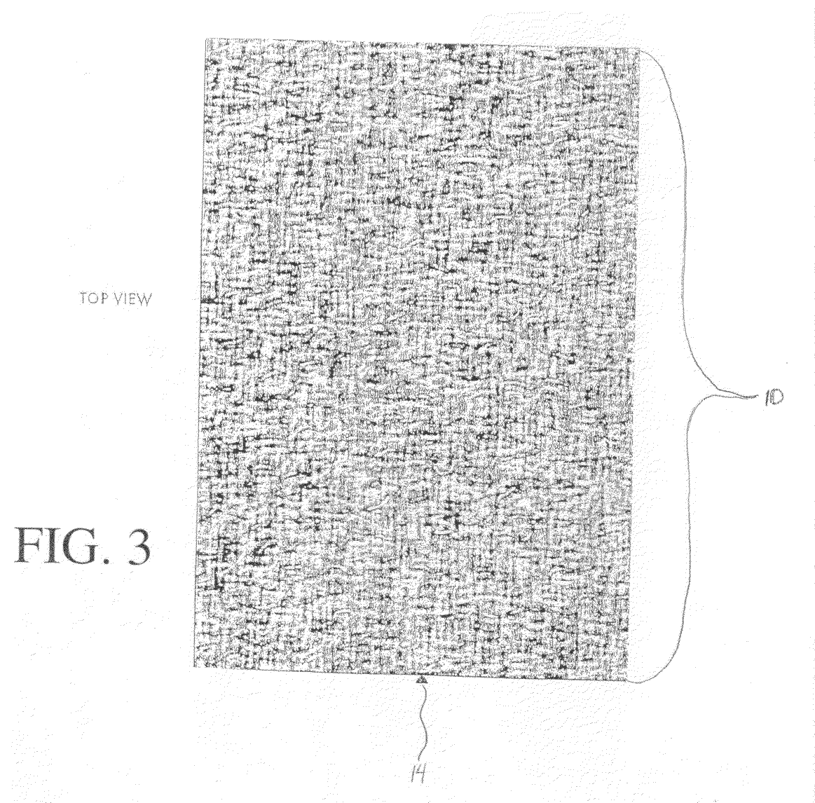

With reference to FIGS. 3 and 4, the top view of the patch is the first of the plurality of surface layers that is adhesively coupled to the foam cushion mid panel 16 and has an adhesive surface 14. The adhesive surface when not in use is protected by a thin plastic film 15. The adhesive surface 14 is used to adhere to the outer perimeters of the vehicle tire and hold the snow and ice patch securely in place. Once the patch is securely in place on the vehicle tire the abrasive surface 13 is exposed to come in contact with the ground.

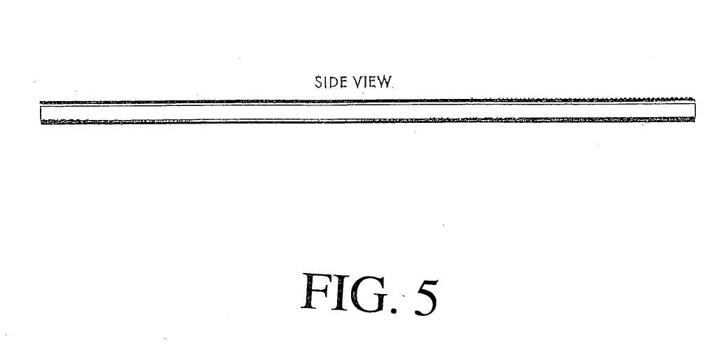

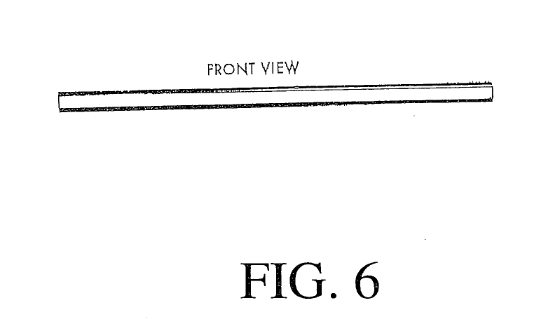

FIG. 4 illustrates a perspective view of the snow and ice patch showing the different layers that it comprises. The mid panel foam cushion 16 is the base of the snow and ice patch with a plurality of surface layers 13 and 14 adhesively coupled to it. The top of the patch contains the adhesive surface 14 that attaches to the vehicle tire. The adhesive surface 14 is protected by an adhesive cover which is a plastic film 15 that peels away to expose the adhesive. The bottom of the patch which is the second of the plurality of surface layers is an abrasive surface 15 that when in contact with the ground surface provides additional traction. FIGS. 5 and 6 illustrate the front and side views of the patch. The front view shows the width of the patch that is about 4 inches while the side view shows the length of the patch which is about 6-7 inches with a thickness of about ¼ of an inch. It should be further obvious to those skilled in the art that the invention may include variations in size, materials, shape, form, function, and manner of operation, assembly, and use

The traction enhancing patch is designed to immediately add traction to a vehicle tire in such adverse weather conditions as snow and ice. The patch is easy to use, attach, remove, and store; thus making it ideal over present tire traction enhancing devices.

All of the above information illustrated in the drawings and described in the specification is intended to be encompassed by the present invention. Therefore, the forgoing is considered as illustrative only of the principles of the invention. Further, since numerous modifications and changes will readily occur to those skilled in the art, it is not desired to limit the invention to exact construction and operation shown and described, and accordingly, all suitable modifications and equivalents may be resorted to, falling within the scope of the invention.

I claim:

1. A snow and ice patch for tires, comprising:
a flat and rectangular panel that is flexible for adhering to curved surfaces;
said flat and rectangular panel having a plurality of opposite surface layers and a thin plastic outer film;
said flat and rectangular panel having an adhesive on the first of said plurality of surface layers, wherein said adhesive allows the panel to be temporarily affixed to the surface of the tire;
said flat and rectangular panel having an abrasive gripping surface on the second of the plurality of surface layers, said abrasive gripping surface provides extra traction in slippery conditions such as snow and ice
said flat and rectangular panel having a thin plastic outer film attached to said first of the plurality of surface layers, wherein the outer film having a lesser thickness than the plurality of layers is flexible and can be peeled away to reveal said adhesive of the first of the plurality of layers on the panel.

2. The snow and ice patch of claim 1 wherein said flat and rectangular panel is composed of a foam cushion.

3. The snow and ice patch of claim 1 wherein said surface layers are flexible.

4. The snow and ice patch of claim 1 wherein said surface layers can bend to fit the curved surface of the vehicle tire.

5. The snow and ice patch of claim 1 wherein said adhesive has a sticky surface.

6. A snow and ice patch for tires comprising:
a flat and rectangular panel with a tire surface side and a traction enhancing side;
said tire surface side having an adhesive backing that is protected by a thin plastic film,
wherein said thin plastic film may be peeled away to expose a sticky surface that can be affixed to the surface of a tire;
said traction patch side having an abrasive gripping surface wherein the surface when in contact with slippery conditions, provides extra traction.
